(19) United States
(12) Patent Application Publication
(10) Pub. No.: US 2017/0173809 A1
(43) Pub. Date: Jun. 22, 2017

(54) A RAZOR HANDLE COMPRISING AN INSERT WITHIN A HOLE AND RAZOR COMPRISING SUCH A RAZOR HANDLE

(71) Applicant: BIC-VIOLEX SA, Anixi, Attiki (GR)

(72) Inventors: Ioannis-Marios Psimadas, Vrilisssia-Athens (GR); Spiros Gratsias, Kipseli-Athens (GR); Georgios Georgakis, Melisia (GR); Efstratios Christofidellis, Kifisia (GR)

(73) Assignee: BIC-VIOLEX SA, Anixi, Attiki (GR)

(21) Appl. No.: 15/325,192

(22) PCT Filed: Aug. 4, 2014
(86) PCT No.: PCT/EP2014/066733

§ 371 Date: Jan. 10, 2017

(51) Int. Cl. B26B 21/52; B26B 21/22

(52) U.S. Cl. CPC B26B 21/522; B26B 21/521; B26B 21/528; B26B 21/222

(57) ABSTRACT

A razor handle extends in a longitudinal direction between a front end and a rear end, and includes an elongated body. The rear end is opposite the front end. The elongated body has an outer surface and is provided with a first hole. The first hole opens on the outer surface. The razor handle further includes a first insert partially encapsulated within the first hole. The first insert is centered on a first point which is located at a distance measured along the longitudinal direction greater than 15% of the length of the razor handle from the front end.

This application is a national stage application of International Application No. PCT/EP2014/066733, filed Aug. 4, 2014, the entire contents of which is incorporated herein by reference.

### FIELD OF THE INVENTION

The embodiments of the present invention relate to a razor handle, a razor and to a method of manufacturing a razor handle.

### BACKGROUND OF INVENTION

In particular, the present invention relates to a razor handle extending in a longitudinal direction between a front end and a rear end, the rear end being opposite the front end, and including an elongated body, the elongated body having an outer surface and being provided with a first hole, the first hole opening on the outer surface and the razor handle further including a first insert partially encapsulated within the first hole.

WO 2009098632 recites an example of a razor handle including a core and an insert which is placed in a channel of the core and can be produced with low manufacturing costs.

However, the insert of WO 2009098632 extends along a large part of the razor handle; therefore, the insert does not provide a good distribution of the weight of the razor handle and does not permit obtaining an optimum location of its center of gravity.

### SUMMARY OF THE INVENTION

One objective of the present invention is to avoid this drawback. Another objective is to improve razor handle by properly distributing the handle weight according to the present invention.

These objectives are solved by the fact that, according to the present invention, the first insert is centered on a first point which is located at a distance measured along the longitudinal direction greater than 15% of the length of the razor handle from the front end.

Due to the insert, the razor handle can have a proper weight which is localized at a chosen position of the razor handle, enhancing user handling to improve shaving performance. The insert thus allows the razor handle to have a good balance regardless the shape of the handle.

In addition, since the insert is encapsulated within the elongated body, the insert cannot be detached from the first hole. Also, such a razor handle has a better hold and provides an improved integrity of the razor handle as a single piece. Furthermore, such a razor handle according to the present invention can be easily recycled by separating the material of the inserts from the material of the elongated body.

Furthermore, the weight of the razor handle can be increased because to the insert without increasing plastic volume of the razor handle.

In advantageous embodiments of such a razor handle, one and/or the other of the following features may be incorporated:
the first point is located at a distance measured along the longitudinal direction of at least 20% of the length of the razor handle from the front end;
the first point is located at a distance measured along the longitudinal direction of at least 25% of the length of the razor handle from the front end;
the first insert is centered on a first point which is located at a distance measured along the longitudinal direction of at least 30 mm from the front end;
the first insert is press-fitted or insert molded within the first hole;
the elongated body is a unitary element and includes a material chosen among plastics;
the first insert is made of a rigid material having a density that is different from the density of the material of the elongated body;
the first insert includes a material chosen among metals, plastics, and rubbers;
the first insert is a sphere and has a diameter measured in a direction perpendicular to the longitudinal direction between about 40% and about 80% of the largest width of the elongated body;
the first insert is a sphere and has a diameter which is between about 10 mm and about 20 mm;
the elongated body has an upper face and a lower face, the lower face being opposite the upper face, the first hole being a blind hole opening on the upper face;
the first insert within the first blind hole forms a finger rest area;
the first hole is a through-hole extending between the upper and lower faces;
the first insert is immovable within the first through-hole, the immovable first insert forming a finger rest area;
the first insert is movable within the first hole;
the front end is provided with connecting means for connection to a shaving cartridge;
the front end is further provided with a lock and release mechanism;
the lock and release mechanism includes a slide element cooperating with the connecting means and connected to the elongated body, the slide element being movable on the razor handle;
the slide element is further provided with a finger rest area to push a shaving cartridge away from the razor handle;
the first hole has an interior lateral wall, the first hole further including two projections, opposite each other, protruding from the interior lateral wall and having a shape that is partly complementary to the shape of the first insert to maintain the first insert within the first hole;
the first hole delimits a first interior space included inside the elongated body, the shape of the first interior space being complementary to the shape of the first insert so that the first insert fits in a snug manner within the first hole;
the elongated body is provided with a second hole located in proximate to the rear end, the second hole opening on the outer surface of the elongated body, the razor handle further including a second insert partially encapsulated within the second hole;
the second insert is a sphere and has a diameter measured in a direction perpendicular to the longitudinal direction between about 40% and about 80% of the largest width of the elongated body;
the second insert is a sphere and has a diameter which is between about 10 mm and about 20 mm;
the second hole delimits a second interior space included inside the elongated body, the shape of the second interior space being at least partly complementary to the shape of the second insert so that the second insert fits in a snug manner within the second hole;
the second insert is centered on a second point which is located at a distance measured along the longitudinal direction of less than 20% of the length of the razor handle from the rear end;
the second insert is centered on a second point which is located at a distance measured along the longitudinal direction of less than 20 mm from the rear end;
the distance between the first point and the second point measured along the longitudinal direction is between about 50% and about 70% of the length of the razor handle; and
the distance between the first point and the second point measured along the longitudinal direction is between about 75 mm and about 85 mm.

The present invention also concerns a razor including such a razor handle and a shaving cartridge connected to the razor handle.

The above and other objects and advantages of the present invention will become apparent from the detailed description of one embodiment of the present invention, considered in conjunction with the accompanying drawings.

### BRIEF DESCRIPTION OF THE DRAWINGS

FIG. 1 is a perspective view of a razor according to the present invention including a razor handle and a shaving cartridge;

FIGS. 2A and 2B are respectively an upper view and a lower view of the razor handle of FIG. 1;

FIG. 3 is a side view of the razor handle of FIG. 1;

FIG. 4 is a longitudinal section view of the razor handle shown in FIG. 2A along line IV-IV;

FIG. 5 is a longitudinal section view of the razor 30 handle shown in FIG. 2A along line V-V;

FIG. 6 is a longitudinal section view of the razor handle shown in FIG. 2A along line VI-VI; and

FIGS. 7A to 7G are perspective views showing the razor handle and its mirror image according to the present invention, and illustrate various ways of grasping the razor handle, depending of the shaving positions.

### DETAILED DESCRIPTION OF THE DISCLOSURES

In the various figures, the same references denote identical or similar elements.

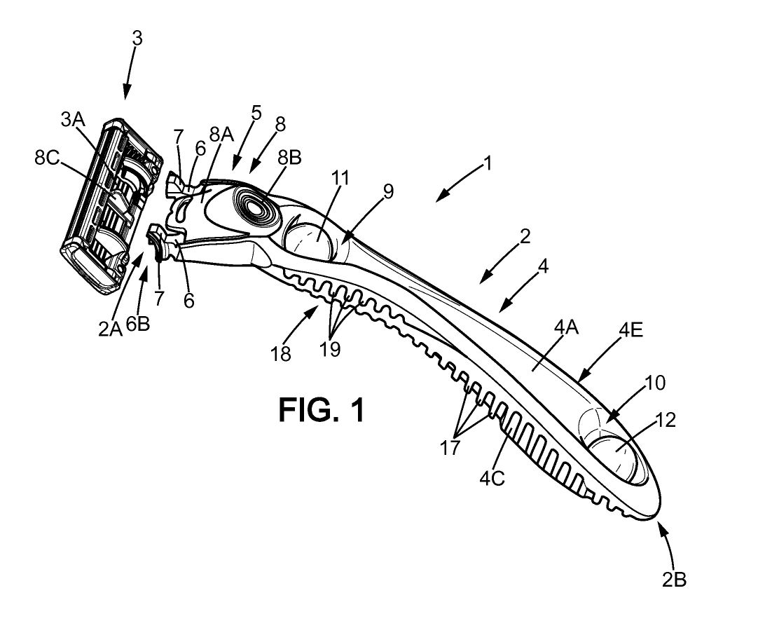

FIG. 1 illustrates a wet shaving razor 1. The shaving razor 1 of the present invention includes a razor handle 2 and a shaving cartridge 3. The shaving cartridge 3 is a disposable shaving cartridge, including one or several blades 3A. The shaving cartridge 3 can be connected to or released from the razor handle 2.

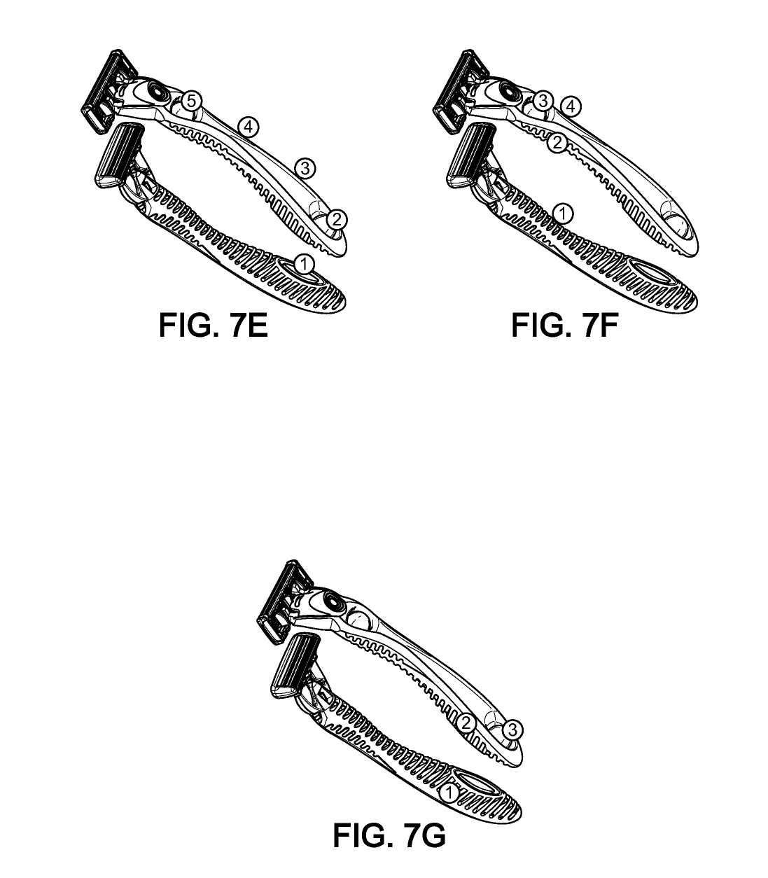

The following description will make reference to different hand grasping positions of the razor handle 2. Various positions are illustrated on FIGS. 7A to 7G, where the numbers in circles designate the fingers of the human hand: (1) the thumb, (2) the index, (3) the second finger, (4) the ring finger and (5) the small finger. The depicted positions of FIGS. 7A, 7B, 7C, 7D, 7E, 7F and 7G are respectively called first position, second position, third position, fourth position, fifth position, sixth position and seventh position.

The razor handle 2 has a generally curved shape when seen from the side and extends in a longitudinal direction C between a front end 2A and a rear end 2B, the rear end 2B being opposite the front end 2A. The razor handle 2 also has an elongated body 4 for hand grasping the razor handle 2. More precisely, the elongated body 4 extends longitudinally from the rear end 2B to a location near the front end 2A. The razor further includes connecting means 5 in the continuation of the elongated body 4 up to the front end 2A. In other words, the elongated body 4 extends longitudinally from the rear end 2B to the beginning of the connecting means 5. The shaving razor 1 extends longitudinally from the rear end 2B to the free end of the connecting means 5, the free end to be connected to the shaving cartridge 3.

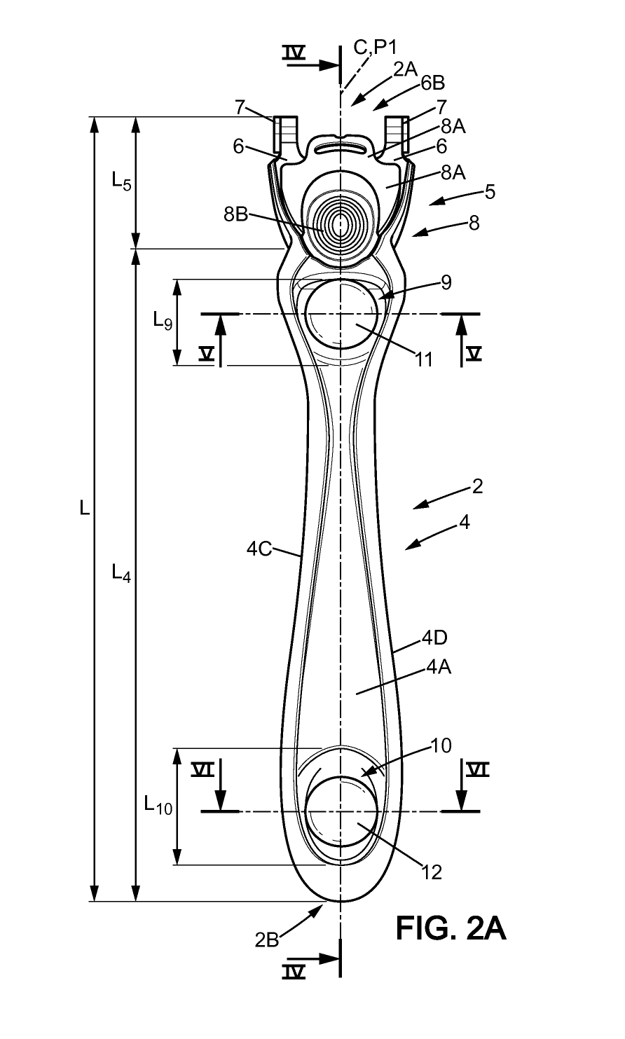

Referring to FIGS. 2A and 2B, the razor handle 2 can be substantially symmetrical with respect of a median plane P1 and has a length L in the longitudinal direction C. The length L4 of the elongated body 4 measured along the longitudinal direction C can be between about 60% and about 80% of the length L of the razor handle 2. The length L5 of the connecting means 5 measured along the longitudinal direction C can be between about 20% and about 40% of the length L of the razor handle 2. For example, the length L in the longitudinal direction C can be between about 100 mm and about 150 mm, alternatively about 125 mm. The length L4 of the elongated body 4 can be between about 80 and about 200 mm, alternatively between about 90 mm and about 110 mm, whereas the length L5 of the connecting means 5 can be between about 25 mm and about 35 mm.

For instance, the length L of the razor handle 2 is about 126 mm. The length L5 of the connecting means 5 is about 29 mm. The length L4 of the elongated body 4 is about 95 mm.

The razor handle 2 may also define a variable height H and a width W along the length L thereof. The height H of the razor handle 2 may vary along the direction C, but can be included between about 15 mm and about 25 mm, alternatively about 20 mm.

As shown in the upper and lower views of the razor handle 2 of FIGS. 2A and 2B, the razor handle 2 also has a first enlarged part Ep1 proximate to the front end 2A, having a largest width W1 which is maximized with regard to the general shape of the razor handle 2.

The elongated body 4 also includes a second enlarged part Ep2 located proximate to the rear end 2B of the razor handle 2 having a width W2 which is also maximized. These enlarged parts Ep1, Ep2 allow for easy and comfortable finger positioning before and during shaving operations, for example in the third position as depicted on FIG. 7C.

The first enlarged part Ep1 extends from the connecting means 5 to the second enlarged part Ep2. The first and second enlarged part Ep1, Ep2 have a length LEp1, LEp2 along the longitudinal direction C. The length LEp1 of the first enlarged part Ep1 measured along the longitudinal direction C can be between about 5% and about 15% of the length L of the razor handle 2. The length Ep2 of the second enlarged part Ep2 measured along the longitudinal direction C can be between about 50% and about 70% of the length L of the razor handle 2. For instance, the length LEp1 of the first enlarged part Ep1 can be about 13 mm whereas the length LEp2 of the second enlarged part Ep2 can be about 75 mm.

The connecting means 5 can be integral with the elongated body 4 and may include two flexible arms 6 which extend from the elongated body 4 and protrude towards a free end 6B at the front end 2A of the razor handle 2. In other words, the flexible arms 6 and the elongated body 4 can be unitary.

As depicted on FIG. 1, the two arms 6 may be disposed in a V shape, diverging from the longitudinal direction C of the razor handle 2 each provided, at the free end 6B, with a bearing structure 7 for connection to the shaving cartridge 3. In the illustrated embodiment of the present invention, the shaving cartridge 3 is of the pivotal type, with the bearing structures 7 allowing the pivoting of the shaving cartridge 3 when connected to the razor handle 2. However, in other embodiments of the present invention, the shaving cartridge 3 may also be fixed relative to the razor handle 2.

The front end 2A of the elongated body 4 may be provided with a lock and release mechanism 8. For instance, the lock and release mechanism 8 can include a slide element 8A cooperating with the connecting means and connected to the elongated body 4, the slide element 8A being movable on the razor handle 2. The shaving cartridge 3 can be clipped into place by a simple pressing action on the elongated body 4. The slide element 8A is further provided with a finger rest area 8B. To replace the shaving cartridge 3, a user can press on the finger rest area 8B provided on the razor handle 2 using thumb pressure. The slide element 8A is connected to the flexible arms 6, which causes the flexible arms 6 to move towards one another. The slide element 8A also cooperates with a groove 8C formed on the shaving cartridge 3 and releases the shaving cartridge 3. Conveniently, the lock and release mechanism 8 is provided at a location that corresponds to that of the user's thumb when in use, enabling a shaving cartridge 3 to be clipped into place and removed by holding the razor handle 2 with one hand and the shaving cartridge 3 in the other.

The elongated body 4 has an outer surface 4E, and more precisely an upper face 4A and a lower face 4B as depicted on FIGS. 2A and 2B, the lower face 4B being opposite the upper face 4A. The elongated body 4 also has two lateral sides 4C, 4D included between the upper and lower faces 4A, 4B, opposite each other and also extending in the longitudinal direction C.

In FIGS. 2A and 2B, each lateral side 4C, 4D is convex, except in the vicinity of the connecting means 5, where the connecting means 5 has a concave portion designed for facilitating hand grasping, especially in the first, second, and sixth positions (FIGS. 7A, 7B and 7F), and also in the vicinity of the rear end 2B, where each lateral side 4C, 4D has a concave portion also designed for facilitating hand grasping, especially in the fourth position (FIG. 7D) and seventh position (FIG. 7G).

The elongated body 4 and the connecting means 5 can form a unitary element. The elongated body 4 and the connecting means 5 can be molded out of a material during a single step of a manufacturing process. The elongated body 4 and the connecting means 5 can be mulded out of the same material. The material may be any moldable material. The material is chosen among plastics, metals, such as metal alloys, and rubbers. For instance, the elongated body 4 and the connecting means 5 can be molded in a thermoplastic material, for example in acrylonitrile butadiene styrene (ABS) or in polypropylene (PP).

As depicted on the figures, the elongated body 4 includes a first hole 9. The first hole 9 is located in the 15 first enlarged part Ep1 of the razor handle 2. As illustrated on FIGS. 2A, 2B, the first hole 9 is a blind hole that opens only on the outer surface 4E of the elongated body 4, and in particular only on the upper face 4A or only on the lower face 4B. However, the first hole 9 may also be a through-hole that extends between the upper face 4A and the lower face 4B of the elongate body 4. Alternatively, the first hole 9 may be a through hole that extends between the lateral sides 4C, 4D of the elongated body 4.

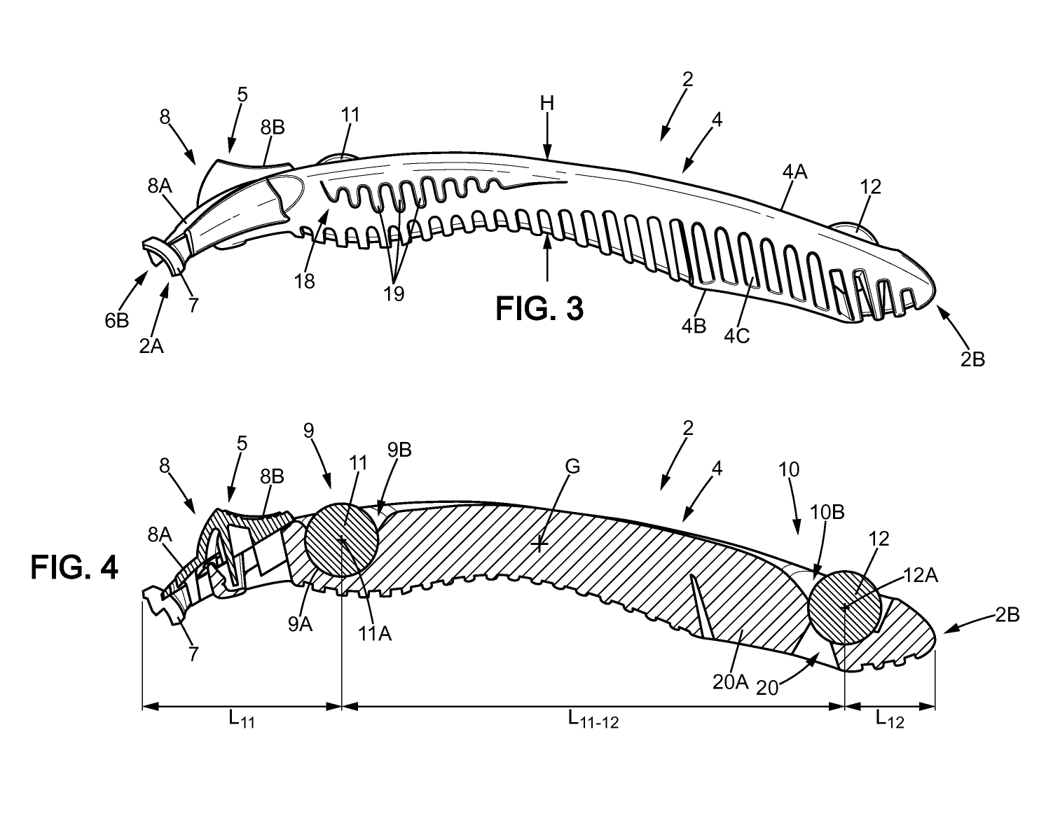

As shown in FIG. 4, the first hole 9 has an interior lateral wall 9A delimiting a first interior space 9B. The first interior space 9B is included inside the elongated body 4. More particularly, the interior lateral wall 9A of the first hole 9 has a substantially circular shape when seen from an upper or a lower view as illustrated in FIG. 2A and 2B. The first hole has a length L9 along the longitudinal direction. The length L9 may be between about 5% and about 20% of the length L of the razor handle 2 in the longitudinal direction C. For instance, the length L9 of 35 the first hole 9 can be between about 10 mm and about 20 mm, alternatively about 15 mm. Also, as illustrated in FIG. 2B, the first enlarged part Ep1 extends from the connecting means 5 to the end of the first hole 9 located towards the center of the razor handle 2. The second enlarged part Ep2 extends from the first enlarged part Ep1 (from the end of the first hole 9 located towards the center of the razor handle 2) to the rear end 2B.

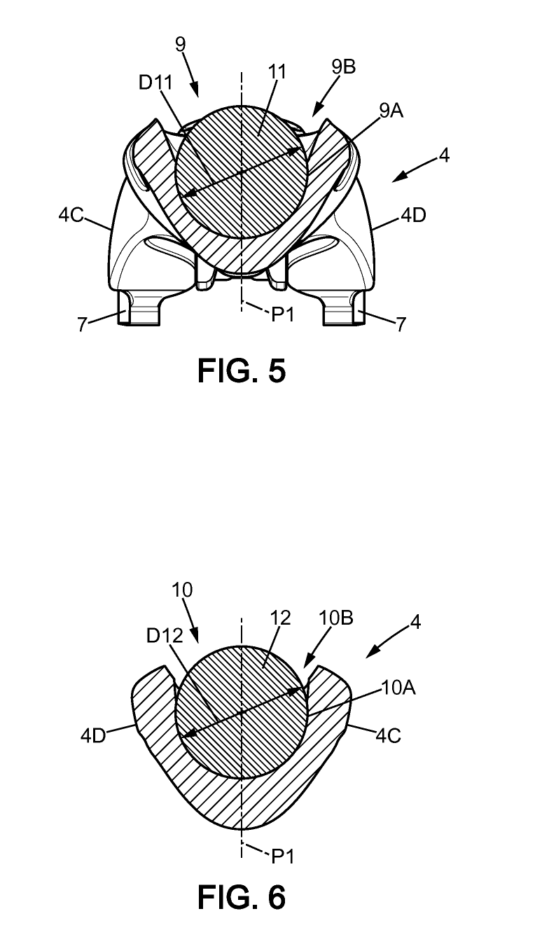

The razor handle 2 further includes a first insert 11 located within the first interior space 9B of the first hole 9. More precisely, the first insert 11 is partially encapsulated within the first hole 9 as illustrated in FIGS. 4 and 5.

The first insert 11 has a size which is smaller than the first interior space 9B of the first hole 9. Also, as illustrated on FIGS. 2A, in the longitudinal direction C, the length L9 of the first hole 9 is greater than the longitudinal size of the first insert 11. More particularly, in the embodiment of the present invention in which the first insert 11 is a sphere as depicted on the figures, the sphere can have a diameter D11 measured in a direction perpendicular to the longitudinal direction C which is between about 40% and about 80% of the largest width W1 of the elongated body 4. For example, the diameter D11 is between about 10 mm and about 20 mm, alternatively less than about 15 mm, and alternatively about 12 mm, whereas the largest width W1 is of about 16 mm.

According to the present invention, the first insert 11 is maintained, and advantageously secured, within the first hole 9 and can therefore not be detached from the first hole 9 by a user.

The elongated body 4 may also be provided with a second hole 10 located proximate to the rear end 2B. The second hole 10 opens on the outer surface 4E of the elongated body 4. The elongated body 4 thus includes a first hole 9 and a second hole 10. The first and second holes 9, 10 are respectively located in the first enlarged part Ep1 and in the second enlarged part Ep2 of the razor handle 2.

The first and second holes 9, 10 may be blind holes or 5 through holes that extend between the upper face 4A and the lower face 4B of the elongate body 4. Alternatively, the first and second holes 9, 10 may be through-holes that extend between the two lateral sides 4C, 4D. As illustrated on FIG. 4, the first hole 9 is a blind hole that opens on the upper face 4A and the second hole is a through hole 10 that extends between the upper face 4A and the lower face 4B. The second hole 10 has a length L10 along the longitudinal direction C as shown on FIG. 2A.

As shown in FIGS. 4, 5 and 6, the second hole 10 also has an interior lateral wall 10A delimiting a second interior space 10B included inside the elongated body 4 between the upper and the lower faces 4A, 4B.

The razor handle 2 further includes a second insert 12 located within the second interior space 10B of the second hole 10. More precisely, the second insert 12 is also partially encapsulated within the second holes 10 as illustrated in FIG. 1.

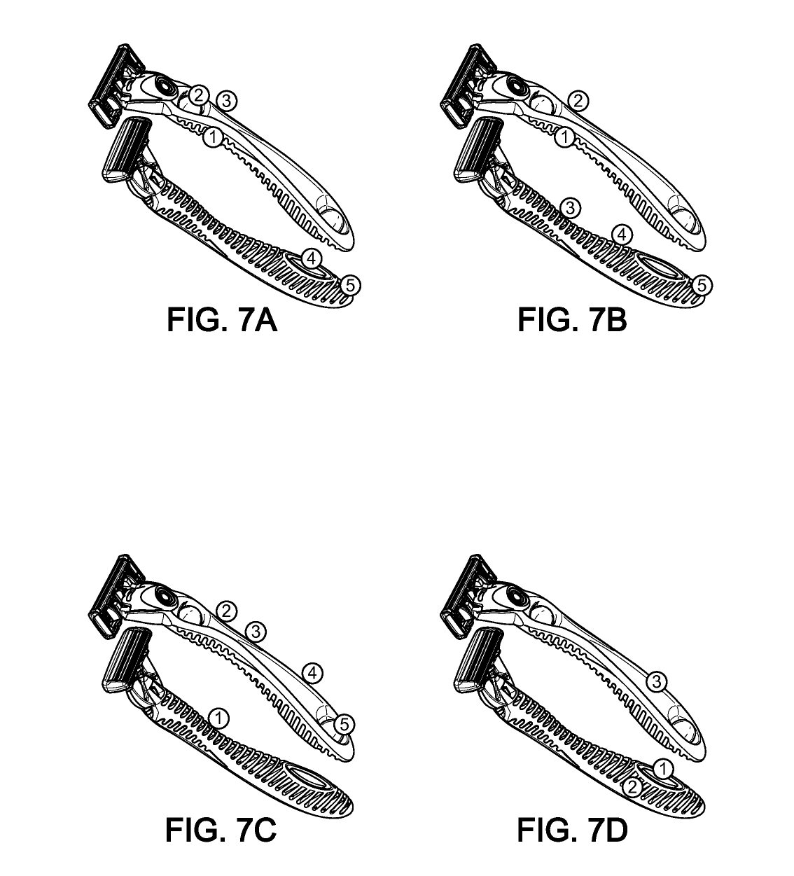

As depicted in FIGS. 5 and 6, the shape of the first and second interior space 9B, 10B are at least partly complementary to the shape of the first and second inserts 11, 12 so that the first and second insert 11, 12 fit in a snug manner respectively within the first and second hole 9, 10.

According to the present invention, the surface of the first insert 11 and/or second insert 12 can be directly or indirectly, as detailed hereafter, touchable with a finger of a user. Also, the surface of each of the first insert 11 and/or second insert 12 can form finger rest areas on the upper face 4A or on the lower face 4B of the elongated body 4 as depicted on some positions of FIGS. 7A-7G.

Less than 75%, and alternatively less than 50% of the surfaces of the first and second inserts 11, 12 are encapsulated within the first and second holes 9, 10. In other words, the surface of the first and second inserts 11, 12 which is encapsulated cannot be directly touchable by the user as the surface of the first and second inserts 11, 12 is surrounded with the material of the elongated body 4.

In this manner, when a user wants to shave, he may position his fingers on the location of the first hole 9 and/or second hole 10, and on the surfaces of the first insert 11 and/or second insert 12 which are not encapsulated. The locations of the first insert 11 and/or second insert 12 provide improved gripping and finger rest comfort in certain shaving positions, such as the first position (FIG. 7A), where the index of the user is located at a distance of the skin to be shaved allowing for precise and comfortable shaving.

The first insert 11 may enhance hand grasping in certain shaving positions, such as in a position where the razor handle 2 is held between the index and the thumb, the thumb resting on the first insert 11 on the upper face 4A whereas the index rests on the first insert 11 on the lower face 4B of the razor handle 2.

The density of the first insert 11 and/or the second insert 12 may be greater than the density of the material of the elongated body 4. The first insert 11 and/or the second insert 12 thus contribute to increase the weight of the razor handle 2 without significantly increasing the volume of the handle 2. As a consequence, the razor handle 2 can be heavy enough to provide a good shaving experience and to make sure that good contact is provided between the blades 3A of the shaving cartridge 3 and the skin of the user to be shaved. In at least one embodiment of the present invention, each of the first and second inserts 11, 12 is only made of metal and does not include any other material. The material chosen for the first insert 11 and/or the second insert 12 may also have an impact on the sensing experience of the user when he positions his fingers on the first and second inserts 11, 12. For example, an insert made of metal provides a pin-point contact with the fingers of the user, thus allowing the communication of all transmitted vibrations from shaving. To the contrary, an insert made of rubber, such as thermoplastics, absorbs most of the vibrations from shaving and does not transmit the vibrations to the fingers of the user.

Since the material of the first and second inserts 11, 12 are different from the material of the elongated body 4, the user can easily determine through touch whether his fingers are well placed on the first insert 11 and/or the second insert 12 of the razor handle 2. By determining the location of the first and second inserts 11, 12, the user can also be guided to place his fingers on the free space of the first hole 9 and/or the second hole 10 that may serve as finger rest areas. In the case that the razor handle 2 includes two inserts, the first and second inserts 11, 12 may not be both necessarily of the same material. For instance, the first insert 11 provided within the first hole 9 may be made of metal and the second insert 12 provided within the second hole 10 may be made of rubber or vice versa.

The first insert 11 and/or the second insert 12 can also be made with several materials. In particular, the first insert 11 and/or the second insert 12 can be covered with a layer of another material having a smooth surface. For example, the first insert 11 and/or the second insert 12 may be made of metal and covered by a layer of rubber. In this case, the layer can have a surface finish of between about 0.5 pm and about 1.6 pm (roughness Ra).

The first insert 11 and/or the second insert 12 may also have an irregular surface, for instance with craters or bumps due to a knurled pattern or a divot pattern. The type of surface of the first insert 11 and/or the second insert 12 effects the tactile sensing of the user when he positions his fingers on the first and second inserts 11, 12.

In at least one embodiment of the present invention, the first insert 11 and/or the second insert 12 may be a sphere of which one hemisphere is made of rubber and the other hemisphere is made of plastic. The first and second inserts 11, 12 may thus serve a double purpose by providing different types of finger rest areas. Due to the first insert 11 and/or the second insert 12, the elongated body 4 can therefore be in a material which is lighter and cheaper when compared to the material used in known razor handles. Nevertheless, despite the lightness of the material, the razor handle 2 still has a high quality appearance and an optimized weight because of the first insert 11 and/or the second insert 12.

The first insert 11 and/or the second insert 12 may have a spherical shape. The first inserts 11 and/or the second insert 12 may have an ovoid shape. The inserts 11, 12 may have any other shape such as a parallelipipedic, cubical or cylindrical shape. The first and second inserts 11, 12 may have the same shape or may have a different one. Similarly, first and second inserts 11, 12 may have the same dimensions or may have different ones. Also, the first and second inserts 11, 12 may include the same material(s) or may include a different one(s).

The inclusion of the first insert 11 and/or the second insert 12 does not lead to an excessive deformation of the shape of the elongated body 4. The shape of the elongated 4 remains substantially similar to the shape of an elongated body that does not include any inserts. As depicted on the Figures, the first insert 11 and/or the second insert 12 is a single sphere. However, each of the first and second inserts 11, 12 may not be complete spheres and may only have a partial curved surface, especially a partial spherical surface which serves as a finger rest area. In the illustrated embodiment of the present invention in which the inserts are spheres as depicted on the figures, such spheres have a respective diameter D11, D12 measured in a direction perpendicular to the longitudinal direction C which is between about 40% and about 80% of the largest width W1 of the elongated body 4. For example, the respective diameters D11, D12 are between about 10 mm and about 20 mm, alternatively less than about 15 mm, and alternatively about 12 mm.

The first insert 11 and/or the second insert 12 may be press-fitted or insert molded within the first hole 9 and/or the second hole 10.

In at least one embodiment of the present invention, the first insert 11 and/or the second insert 12 are maintained, and advantageously secured, respectively within the first and second holes 9, 10 and can therefore not be detached from the first and second holes 9, 10 by a user. The first and second inserts 11, 12 cannot move in any manner in the first and second holes 9, 10. As a consequence, the first insert 11 and/or the second insert 12 are not movable (i.e. immovable or motionless) respectively relative to the first and second holes 9, 10.

The non-movable first and second inserts 11, 12 thus form finger rest areas.

The first insert 11 and/or the second insert 12 may also be movable. The first insert 11 and/or the second insert can, for instance, be spheres that are movable, such as in sliding around their own axis within their corresponding first and second holes 9, 10. Also, a gap may be provided between the first insert 11 and/or the second insert 12 and the interior wall 9A, 10A of the first and second holes 9, 10 in order to facilitate the rotation of the first insert 11 and/or the second insert 12 when the inserts 11, 12 are a sphere. The gap may be between about 0.005 pm and about 0.025 pm depending on the chosen rotational freedom of the first insert 11. A smaller gap prevents the first insert 11 from rotating easily whereas a bigger gap facilitates the rotation. The surface finish of the first insert 11 and/or the second insert 12 and/or of the first hole 9 and/or the second hole 10 is adapted to allow this movability, especially the rotation.

However, a user that may position one of his fingers on such a movable first insert 11 and/or second insert 12 may find it difficult to shave as his finger(s) may constantly slip on the first insert 11 and/or the second insert 12. Shaving may therefore be imprecise and uncomfortable. As a consequence, when the first insert 11 and/or the second insert is movable respectively relative to corresponding first or second holes 9, 10, it does not best function as fingers rest areas.

More precisely, when the first the first insert 11 is movable, it cannot be a finger rest area. The first insert 11 is located in the front end 2A of the razor handle 2. The first insert 11 is centered on a first point 11A which is located at a distance L11 measured along the longitudinal direction C from the front end 2A. Preferably, the distance L11 measured along the longitudinal direction

C that is greater than about 15% of the length L of the razor handle 2. The distance L11 measured along the longitudinal direction C may be greater than 20% of the length L of the razor handle 2. Alternatively, the distance L11 measured along the longitudinal direction C is at least about 25% of the length L of the razor handle 2.

The distance L11 may be between about 25% and about 40% of the length L of the razor handle 2 in the longitudinal direction C. For example, the distance L11 may be at least 35 mm from the front end 2A. Thus, the weight of the razor handle 2 is chosen to ensure a good balance. Also, in the present invention, by adding the first insert 11 at a precise location, for instance at least 15% of the length L of the razor handle 2, it is possible to control the location of the center of gravity G regardless of the shape of the razor handle 2.

The second insert 12 is centered on a second point 12A which is located at a distance L12 measured along the longitudinal direction of less than 20% of the length L of the razor handle 2 from the rear end 2B. For instance, the distance L12 may be less than 20 mm from the rear end 2B. As illustrated on the Figures, in an embodiment of the present invention in which the first and second inserts 11, 12 are spheres, the first point 11A and the second point 12A respectively correspond to the center of the first and second inserts 11, 12.

The distance L11-12 between the first point 11A and the second point 12A measured along the longitudinal direction C is between about 50% and about 70% of the length L of the razor handle 2. For example, the distance L11-12 may be between about 75 mm and about 85 mm, alternatively about 78 mm. However, this distance L11-12 may vary depending on the length L4 of the elongated body 4 as well as the weight balance due to the first insert 11 and/or the second insert 12.

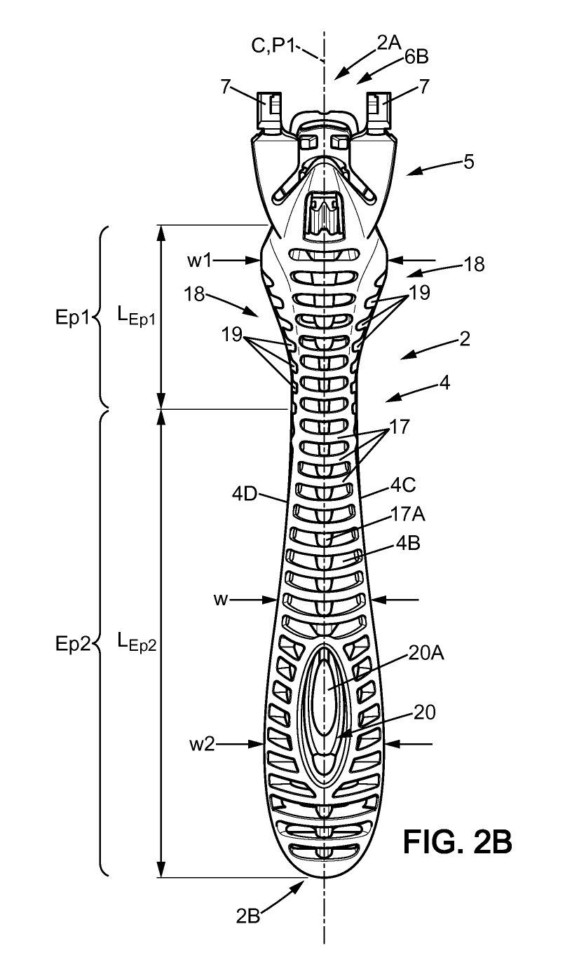

Furthermore, the elongated body 4 may have different shapes. For instance, as depicted in FIGS. 1-6, the upper face 4A can have a smooth surface. The lower face 4B of the razor handle 2 may include a plurality of ribs 17. These ribs 17 extend laterally from a core portion 17A in planes perpendicular to the longitudinal direction C. Also, the ribs 17 cover substantially the entire surface of the lower face 4B. Besides, as illustrated on FIG. 2B, the lower face 4B also includes, proximate to the second hole 10, a cavity 20 having an ovoid shape. The cavity 20 is at least partially filled with a protrusion 20A in the center of the cavity 20. The protrusion 20A extends to the surface of the lower face 4B and may serve as a finger rest area. More precisely, the protrusion 20A enhances hand grasping in certain shaving positions, such as the fourth position (FIG. 7D), or in a position where the razor handle 2 is held between the index and the thumb, the thumb resting on the protrusion 20A whereas the index rests on the second insert 12, the razor handle 2 being in continuation with the fingers. Such a shaving position may be used for horizontal cheek shaving. The protrusion 20A can also be used as a finger rest area in combination with the surface of first insert 11 on the upper face 4A in certain shaving positions such as the first position (FIG. 7A) and the fifth position (FIG. 7E).

The lateral sides 4C, 4D of the elongated body 4 may further include side gripping areas 18 including a plurality of spaced fins 19 located proximate to the first enlarged part Ep1. The side gripping areas 18 enhance finger gripping of the razor handle 2, especially in the first position (FIG. 7A), second position (FIG. 7B) and sixth position (FIG. 7F), which are shaving positions where the thumb and the index finger are positioned very close to the first insert 11 for satisfying the need of precise shaving. More specifically, the fins 19 are parallel and each inclines backwards. Such an inclination improves the ergonomics of the razor handle 2, especially in the first position (FIG. 7A), where the fins 19 extend substantially perpendicular to the axis of the index finger. Also, the plurality of spaced fins 19 defines a comb-like structure, thereby providing better finger gripping in certain positions.

Because of the first and second inserts 11, 12, the razor handle 2 has a center of gravity G whose location can be specifically chosen. The center of gravity G can be located close to the middle part of the razor handle 2 as seen on FIG. 4. The location of the center of gravity G may depend on various factors such as the shape, the density and/or the position of the first and second inserts 11, 12. The center of gravity G may also depend on the general shape of the razor handle 2. The location of the center of gravity G provides an optimum balance of the razor handle as well as improved ergonomics.

1-24. (canceled)

25. A razor handle extending in a longitudinal direction between a front end and a rear end, the rear end being opposite the front end, the razor handle comprising an elongated body, the elongated body having an outer surface and being provided with a first hole, the first hole opening on the outer surface; and the razor handle further comprising a first insert partially encapsulated within the first hole,
wherein the first insert is centered on a first point which is located at a distance measured along the longitudinal direction greater than about 15% of a length of the razor handle from the front end.

26. The razor handle according to claim 25, wherein the first point is located at a distance measured along the longitudinal direction of at least 20% of the length of the razor handle from the front end.

27. The razor handle according to claim 25, wherein the first insert is press-fitted or insert molded within the first hole.

28. The razor handle according to claim 25, wherein the elongated body is a unitary element and comprises a material chosen among plastics.

29. The razor handle according to claim 25, wherein the first insert is made of a rigid material having a density that is different from a density of a material of the elongated body.

30. The razor handle according to claim 25, wherein the first insert comprises a material chosen among metals, plastics, and rubbers.

31. The razor handle according to claim 25, wherein the first insert is a sphere and has a diameter measured in a direction perpendicular to the longitudinal direction between about 40% and about 80% of a largest width of the elongated body.

32. The razor handle according to claim 25, wherein the elongated body has an upper face and a lower face, the lower face being opposite the upper face, the first hole being a blind hole opening on the upper face.

33. The razor handle according to claim 32, wherein the first insert within the first blind hole forms a finger rest area.

34. The razor handle according to claim 32, wherein the first hole is a through-hole extending between the upper and lower faces.

35. The razor handle according to claim 34, wherein the first insert is immovable within the first through-hole, the immovable first insert forming a finger rest area.

36. The razor handle according to claim 25, wherein the first insert is movable within the first hole.

37. The razor handle according to claim 25, wherein the front end is provided with connecting means for connection to a shaving cartridge.

38. The razor handle according to claim 25, wherein the front end is further provided with a lock and release mechanism.

39. The razor handle according to claim 38, wherein the lock and release mechanism comprises a slide element cooperating with the connecting means and connected to the elongated body, the slide element being movable on the razor handle.

40. The razor handle according to claim 39, wherein the slide element is further provided with a finger rest area to push a shaving cartridge away from the razor handle.

41. The razor handle according to claim 25, wherein the first hole has an interior lateral wall having a shape that is partly complementary to a shape of the first insert for maintaining the first insert within the first hole.

42. The razor handle according to claim 25, wherein the first hole delimits a first interior space comprised inside the elongated body, a shape of the first interior space being complementary to a shape of the first insert so that the first insert fits in a snug manner within the first hole.

43. The razor handle according to claim 25, wherein the elongated body is provided with a second hole located proximate to the rear end, the second hole opening on the outer surface of the elongated body, the razor handle further comprising a second insert partially encapsulated within the second hole.

44. The razor handle according to claim 43, wherein the second insert is a sphere and has a diameter measured in a direction perpendicular to the longitudinal direction between about 40% and about 80% of a largest width of the elongated body.

45. The razor handle according to claim 43, wherein the second hole delimits a second interior space comprised inside the elongated body, a shape of the second interior space being complementary to a shape of the second insert so that the second insert fits in a snug manner within the second hole.

46. The razor handle according to claim 43, wherein the second insert is centered on a second point which is located at a distance measured along the longitudinal direction of less than 20% of a length of the razor handle from the rear end.

47. The razor handle according to claim 46, wherein the distance between the first point and the second point measured along the longitudinal direction is between about 50% and about 70% of the length of the razor handle.

48. A razor comprising a razor handle according to claim 25 and a shaving cartridge connected to the razor handle.
